(19) United States
(12) Patent Application Publication
(10) Pub. No.: US 2025/0376103 A1
(43) Pub. Date: Dec. 11, 2025

(54) Truck Bed Tie Down Device

(71) Applicants: William Mark Ruggier, Conway, SC (US); Denise Ruggier, Conway, SC (US)

(72) Inventors: William Mark Ruggier, Conway, SC (US); Denise Ruggier, Conway, SC (US)

(21) Appl. No.: 19/060,888

(22) Filed: Feb. 24, 2025

Related U.S. Application Data
(60) Provisional application No. 63/656,630, filed on Jun. 6, 2024.

(51) Int. Cl. B60P 7/08

(52) U.S. Cl. CPC B60P 7/0823; B60P 7/0807

(57) ABSTRACT

A truck bed tie down device, which is an anchoring system for truck beds, designed to secure and tie down cargo and prevent any errant movement. The truck bed tie down device comprises a chain-like component with a protective cover, a toggle bolt assembly for easy installation and a nylon, UV-resistant pull strap. Further, the pull strap is attached to the chain-like component via a stainless-steel ring that enables easy access to the device from the truck's pockets when needed. Also, the device provides a handy way to lock down equipment and valuables with the addition of a padlock. Thus, the device is easily accessed by being pulled up when needed to secure cargo. After use it is dropped back down and hidden away in the pocket of the truck bed.

### CROSS-REFERENCE TO RELATED APPLICATION

The present application claims priority to, and the benefit of, U.S. Provisional Application No. 63/656,630, which was filed on Jun. 6, 2024, and is incorporated herein by reference in its entirety.

### FIELD OF THE INVENTION

The present invention relates generally to the field of truck bed tie down devices. More specifically, the present invention relates to a cargo security device for pickup truck beds for tying down various types of cargo loads. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in truck bed tie down devices. Generally, tying down and securing cargo can be a difficult task, even with common items like ratchet straps, bungee cords, etc. Further, anchor points on the pickup truck bed can be flimsy and ill fitting, often interfering with options like a tonneau cover, truck caps, and toolboxes. Thus, padlocking cargo for transport in the truck bed may be nearly impossible. Loose cargo can damage the truck bed and even fly out of the bed during transport and become a road hazard.

When securing individual objects in the bed, such as dirt bikes, ATVs, air tanks, furniture, and other items, the ideal condition is to have multiple sturdy tie-down points in close proximity to the object being secured. Although the owner of the truck does have the option of adding permanent tie-down rings, he/she is ordinarily reluctant to do so because the projecting rings tend to interfere with other uses of the truck. They also detract from the appearance of the truck.

Accordingly, there is a demand for an improved truck bed tie down device that secures various types of cargo loads. More particularly, there is a demand for a truck bed tie down device that stows away if not needed.

Therefore, there exists a long felt need in the art for a truck bed tie down device that provides users with a cargo security device for pickup truck beds for tying down various types of cargo loads. There is also a long felt need in the art for a truck bed tie down device that utilizes a strong, durable chain with a protective cover and a nylon, UV-resistant pull strap that work in conjunction to secure cargo at different anchor points around the bed perimeter. Further, there is a long felt need in the art for a truck bed tie down device that features a toggle bolt assembly for easy installation that can be incorporated into the truck bed or by utility trailer owners. Moreover, there is a long felt need in the art for a device that stows away if not needed, offering an improvement over other anchors that protrude from the top rails of the bed. Further, there is a long felt need in the art for a truck bed tie down device that can lock down valuables with the addition of a padlock. Finally, there is a long felt need in the art for a truck bed tie down device wherein the protective cover prevents damage to the pickup truck's rail.

The subject matter disclosed and claimed herein, in one embodiment thereof, comprises a truck bed tie down device. The device is an anchoring system for truck beds, designed to secure and tie down cargo and prevent any errant movement. The truck bed tie down device comprises a chain-like component with a protective cover, a toggle bolt assembly for easy installation and a nylon, UV-resistant pull strap. Further, the pull strap is attached to the chain-like component via a stainless-steel ring that enables easy access to the device from the truck's pockets when needed. Then, when not in use, it allows them to be tucked away and concealed. Additionally, the protective insulator prevents damage to the pickup truck's rail. Also, the device provides a handy way to lock down equipment and valuables with the addition of a padlock. Thus, the device is easily accessed by being pulled up when needed to secure cargo. After use it is dropped back down and hidden away in the pocket of the truck bed.

In this manner, the truck bed tie down device of the present invention accomplishes all of the forgoing objectives and provides users with a device that provides a cargo security device for pickup truck beds. The device has a protective cover. The device can lock down valuables with a padlock.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a truck bed tie down device. The truck bed tie down device comprises a chain-like component, a toggle bolt assembly, and a pull strap. During use, the device is secured within an anchor point of a truck bed. Thus, the device is easily accessed when needed to secure cargo. After use it is dropped back down and hidden away in the pocket of the truck bed.

In one embodiment, the truck bed tie down device is an anchoring system for truck beds, designed to secure and tie down cargo and prevent any errant movement. The truck bed tic down device works to secure cargo at different anchor points around the truck bed perimeter. Further, the truck bed tie down device can be stored away if not needed, offering an improvement over other anchors that protrude from the top rails of the truck bed. The device is then easily accessed by being pulled up when needed to secure cargo within the truck bed.

In one embodiment, the truck bed tie down device is utilized with any suitable truck, utility trailer, or vehicle which has a cargo bed, or area, behind a cab (or passenger compartment). Further, there are two sidewalls on the sides of the cargo bed, with a top rail on the sidewalls and a plurality of anchor points for use with the device positioned on the top rails. Specifically, the truck bed tie down device is designed to be installed in and attached within one of the anchor points/cavities typically provided in the top rails of the side walls of the pickup truck bed or about the periphery of the flat bed of a larger truck or a utility trailer. Further, the anchor points/cavities comprise a rectangular opening in the top surface of the rail or side wall of the cargo bed. Directly below the opening and aligned therewith is a box-like compartment or pocket which secures the truck bed tie down device during storage, allowing a user to pull the pull strap to remove the device for use.

It will be appreciated that the truck bed tie down device described in this patent specification can be used in conjunction with, for example, ropes, straps, rubber tie-downs, bungee cords, and the like, to secure objects to tie-down anchor points throughout the cargo bed.

In one embodiment, the truck bed tie down device comprises a strong, durable chain-like component. The chain-like component can be any suitable length as is known in the art, depending on the needs and/or wants of a user and depending on the size of the object to be secured within the truck bed. The chain-like component is typically a plurality of chain links secured together at their links into a length which is then wrapped around an object, securing it within the truck bed. The links of the chain-like component allow bungee cords, straps, rope, or any other suitable tie downs to be secured to aid with the securing of the objects within the truck bed. Further, the chain-like component comprises a protective cover. The protective cover wraps fully around the chain links, cushioning them and preventing them from damaging the truck. Specifically, the protective cover prevents damage to the pickup truck's rail and other places of contact on the truck's surface. The protective cover is typically an insulated cover of cushioning materials, secured around a length of the chain-like component. The protective cover is secured via any suitable securing means as is known in the art, such as snaps, adhesive, etc.

In one embodiment, the chain-like component is secured to a toggle bolt assembly. Specifically, the toggle bolt assembly is secured to a chain link of the chain-like component. The toggle bolt assembly comprises a pair of spring-loaded wings, with a metal screw positioned in the middle of the wings. The toggle bolt assembly functions as a conventional toggle bolt and allows for easy installation of the device on the truck rails. Specifically, the spring-loaded wings are folded down, such that they fit within the anchor point and are then inserted into an anchor point of the truck bed or within a utility trailer. Once inserted into the anchor point hole, the spring-loaded wings are released, springing open on the other side of the anchor point hole and securing the toggle bolt within the anchor point. The truck bed tie down device can be secured via the toggle bolt assembly to each anchor point of a truck bed, as needed. In one embodiment, the toggle bolt assembly has a drawstring or other suitable means for drawing up and securing the toggle bolt, once it is inserted into the anchor point of the truck bed.

In one embodiment, a nylon, UV-resistant pull strap is secured to the chain-like component. Further, the pull strap is attached to the chain-like component via a stainless-steel ring that enables easy access to the device from the truck's pockets when needed. Specifically, the pull strap is secured via the stainless-steel ring to a chain link of the chain-like component. The pull strap is typically made of nylon and UV-resistant materials to provide durability and protection from weather and other elements, when the device is secured within an anchor point of the truck bed. The pull strap can be any suitable length as is known in the art, depending on a user's needs and/or wants. Further, the pull strap typically comprises a hand loop for a user to insert their hand into, when pulling on the strap. The hand loop is sized and shaped to retain a user's hand or hands, as needed. Once secured to the chain-like component via the stainless-steel ring, a user pulls on the pull strap to tighten the truck bed tie down device, as needed, to secure the object within the truck bed. Further, the pull strap allows easy access to the device from the truck's pockets when needed. Then, when not in use, the chain-like component can be positioned within the truck's pockets, allowing the device to be tucked away and concealed within the pocket and only exposing the pull strap. Thus, the device is easily accessed by pulling up on the pull strap when needed to expose the device and use it to secure the cargo. After use, the device is dropped back down and hidden away in the pocket of the truck bed for storage.

In one embodiment, the device utilizes a padlock to lock down equipment and valuables. Specifically, the padlock is secured to the chain link of the chain-like component, securing the chain-like component around the valuable cargo within the truck bed. Any suitable padlock can be used with the chain-like component as is known in the art.

In operation, a user first presses the pair of spring-loaded wings of the toggle bolt inward. With the wings retracted, the toggle bolt is then inserted into the anchor point and the wings are released, springing outward, securing the toggle bolt within the anchor point. The outward pressure of the wings against the anchor point, locks the toggle bolt within the anchor point. Once secure within the anchor point, the device can be stored within the pocket of the truck with just the pull strap exposed. Then in use, the user grabs the pull strap and pulls the device free of the pocket. The chain-like component is then secured around the cargo, along with other securing means as needed (i.e., bungee cords, straps, etc.) within the truck bed and secured. The user then uses the pull strap to pull and tighten the chain-like component around the cargo. If needed, a padlock is then added to the chain-like component to further secure any valuables within the truck bed.

In yet another embodiment, the truck bed tie down device comprises a plurality of indicia.

In yet another embodiment, a method of securing cargo in a truck bed is disclosed. The method includes the steps of providing a truck bed tie down device comprising a chain-like component with a toggle bolt assembly. The method also comprises securing the toggle bolt assembly to the anchor point on a truck bed. Further, the method comprises securing the chain-like component around an item within the truck bed to be secured. The method comprises tightening the chain-like component via pulling on the pull strap. The method also comprises attaching a padlock to the chain-like component to secure any valuables. Finally, the method comprises un-attaching the device and dropping it into a pocket of the truck bed for storage.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the truck bed tie down device of the present invention showing the device in use in accordance with the disclosed architecture;

FIG. 2 illustrates a perspective view of one embodiment of the truck bed tie down device of the present invention showing the device installed around different anchor points in accordance with the disclosed architecture;

FIG. 3 illustrates a perspective view of one embodiment of the truck bed tie down device of the present invention showing how the device is tightened via a pull strap in accordance with the disclosed architecture;

FIG. 4 illustrates a perspective view of one embodiment of the truck bed tie down device of the present invention showing the addition of a padlock to secure valuables in accordance with the disclosed architecture;

FIG. 5 illustrates a perspective view of one embodiment of the truck bed tie down device of the present invention showing the device and its components in accordance with the disclosed architecture; and

FIG. 6 illustrates a flowchart showing the method of securing cargo in a truck bed in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a truck bed tie down device that provides users with a cargo security device for pickup truck beds for tying down various types of cargo loads. There is also a long felt need in the art for a truck bed tie down device that utilizes a strong, durable chain with a protective cover and a nylon, UV-resistant pull strap that work in conjunction to secure cargo at different anchor points around the bed perimeter. Further, there is a long felt need in the art for a truck bed tie down device that features a toggle bolt assembly for easy installation that can be incorporated into the truck bed or by utility trailer owners. Moreover, there is a long felt need in the art for a device that stows away if not needed, offering an improvement over other anchors that protrude from the top rails of the bed. Further, there is a long felt need in the art for a truck bed tie down device that can lock down valuables with the addition of a padlock. Finally, there is a long felt need in the art for a truck bed tie down device wherein the protective cover prevents damage to the pickup truck's rail.

The present invention, in one exemplary embodiment, is a novel truck bed tie down device. The truck bed tie down device comprises a chain-like component with a protective cover, a toggle bolt assembly for easy installation and a nylon, UV-resistant pull strap. Further, the pull strap is attached to the chain-like component via a stainless-steel ring that enables easy access to the device from the truck's pockets when needed. Additionally, the protective insulator prevents damage to the pickup truck's rail. Also, the device provides a handy way to lock down equipment and valuables with the addition of a padlock. Thus, the device is easily accessed by being pulled up when needed to secure cargo. After use it is dropped back down and hidden away in the pocket of the truck bed. The present invention also includes a novel method of securing cargo in a truck bed. The method includes the steps of providing a truck bed tie down device comprising a chain-like component with a toggle bolt assembly. The method also comprises securing the toggle bolt assembly to the anchor point on a truck bed. Further, the method comprises securing the chain-like component around an item within the truck bed to be secured. The method comprises tightening the chain-like component via pulling on the pull strap. The method also comprises attaching a padlock to the chain-like component to secure any valuables. Finally, the method comprises un-attaching the device and dropping it into a pocket of the truck bed for storage.

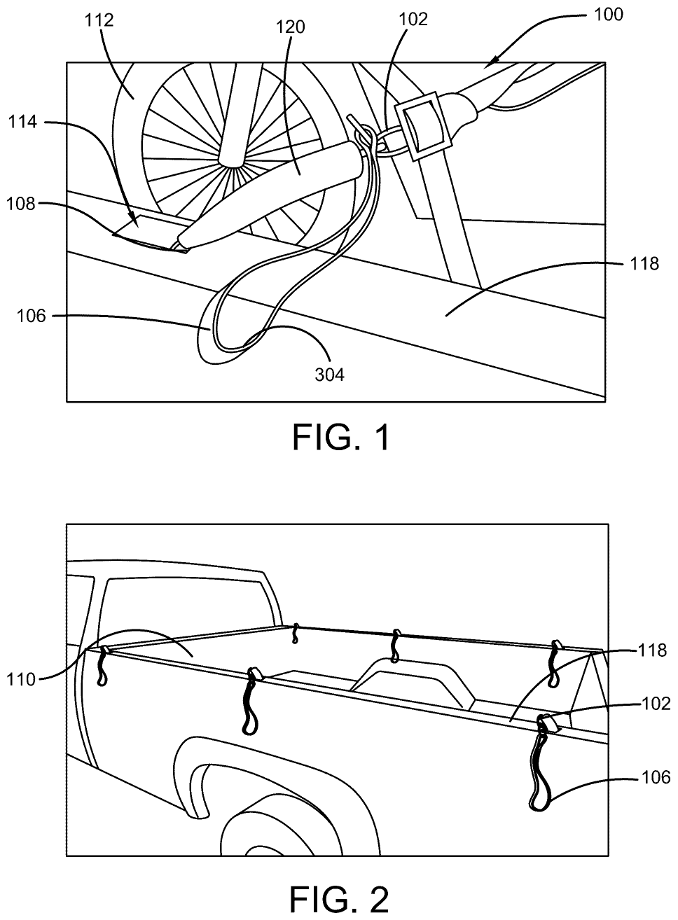

Referring initially to the drawings, FIG. 1 illustrates a perspective view of one embodiment of the truck bed tie down device 100 of the present invention. In the present embodiment, the truck bed tie down device 100 is an improved truck bed tie down device 100 that provides a user 116 with a means for securing cargo 112 in pickup truck beds 110. Specifically, the truck bed tie down device 100 comprises a chain-like component 102, a toggle bolt assembly 104, and a pull strap 106. During use, the device 100 is secured within an anchor point 108 of a truck bed 110. Thus, the device 100 is easily accessed when needed to secure cargo 112. After use it is dropped back down and hidden away in the pocket 114 of the truck bed 110.

Generally, the truck bed tie down device 100 is an anchoring system for truck beds 110, designed to secure and tie down cargo 112 and prevent any errant movement. The truck bed tic down device 100 works to secure cargo 112 at different anchor points 108 around the truck bed perimeter. Further, the truck bed tie down device 100 can be stored away if not needed, offering an improvement over other anchors that protrude from the top rails 118 of the truck bed 110. The device 100 is then easily accessed by being pulled up when needed to secure cargo 112 within the truck bed 110.

Further, the truck bed tie down device 100 is utilized with any suitable truck, utility trailer, or vehicle which has a cargo bed 110, or area, behind a cab (or passenger compartment). Further, there are two sidewalls on the sides of the cargo bed 110, with a top rail 118 on the sidewalls and a plurality of anchor points 108 for use with the device 100 positioned on the top rails 118. Specifically, the truck bed tie down device 100 is designed to be installed in and attached within one of the anchor points/cavities 108 typically provided in the top rails 118 of the side walls of the pickup truck bed 110 or about the periphery of the flat bed of a larger truck or a utility trailer. Further, the anchor points/cavities 108 comprise a rectangular opening in the top surface of the rail 118 or side wall of the cargo bed 110. Directly below the opening and aligned therewith is a box-like compartment or pocket 114 which secures the truck bed tie down device 100 during storage, allowing a user 116 to pull the pull strap 106 to remove the device 100 for use.

It will be appreciated that the truck bed tie down device 100 described in this patent specification can be used in conjunction with, for example, ropes, straps, rubber tie-downs, bungee cords, and the like, to secure objects 112 to tie-down anchor points 108 throughout the cargo bed 110.

Furthermore, the truck bed tie down device 100 comprises a strong, durable chain-like component 102. The chain-like component 102 can be any suitable length as is known in the art, depending on the needs and/or wants of a user 116 and depending on the size of the object 112 to be secured within the truck bed 110. The chain-like component 102 is typically a plurality of chain links secured together at their links into a length which is then wrapped around an object 112, securing it within the truck bed 110. The links of the chain-like component 102 allow bungee cords, straps, rope, or any other suitable tie downs to be secured to aid with the securing of the objects 112 within the truck bed 110. Further, the chain-like component 102 comprises a protective cover 120. The protective cover 120 wraps fully around the chain links, cushioning them and preventing them from damaging the truck. Specifically, the protective cover 120 prevents damage to the pickup truck's rail 118 and other places of contact on the truck's surface. The protective cover 120 is typically an insulated cover of cushioning materials, secured around a length of the chain-like component 102. The protective cover 120 is secured via any suitable securing means as is known in the art, such as snaps, adhesive, etc.

As shown in FIG. 2, the chain-like component 102 is secured to a toggle bolt assembly 104. Specifically, the toggle bolt assembly 104 is secured to a chain link of the chain-like component 102. The toggle bolt assembly 104 comprises a pair of spring-loaded wings 200, with a metal screw 202 positioned in the middle of the wings 200. The toggle bolt assembly 104 functions as a conventional toggle bolt and allows for easy installation of the device 100 on the truck rails 118. Specifically, the spring-loaded wings 200 are folded down, such that they fit within the anchor point 108 and are then inserted into an anchor point 108 of the truck bed 110 or within a utility trailer. Once inserted into the anchor point 108 hole, the spring-loaded wings 200 are released, springing open on the other side of the anchor point 108 hole and securing the toggle bolt 104 within the anchor point 108. The truck bed tie down device 100 can be secured via the toggle bolt assembly 104 to each anchor point 108 of a truck bed 110, as needed. In one embodiment, the toggle bolt assembly 104 has a drawstring 204 or other suitable means for drawing up and securing the toggle bolt 104, once it is inserted into the anchor point 108 of the truck bed 110.

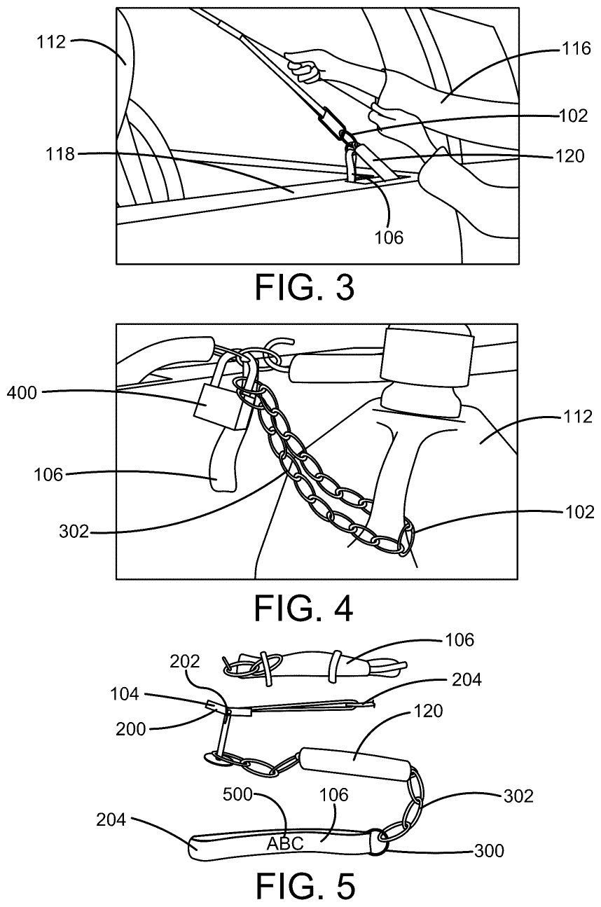

As shown in FIG. 3, a nylon, UV-resistant pull strap 106 is secured to the chain-like component 102. Further, the pull strap 106 is attached to the chain-like component 102 via a stainless-steel ring 300 that enables easy access to the device 100 from the truck's pockets 114 when needed. Specifically, the pull strap 106 is secured via the stainless-steel ring 300 to a chain link 302 of the chain-like component 102. The pull strap 106 is typically made of nylon and UV-resistant materials to provide durability and protection from weather and other elements, when the device 100 is secured within an anchor point 108 of the truck bed 110. The pull strap 106 can be any suitable length as is known in the art, depending on a user's needs and/or wants. Further, the pull strap 106 typically comprises a hand loop 304 for a user 116 to insert their hand into, when pulling on the strap 106. The hand loop 304 is sized and shaped to retain a user's hand or hands, as needed. Once secured to the chain-like component 102 via the stainless-steel ring 300, a user 116 pulls on the pull strap 106 to tighten the truck bed tie down device 100, as needed, to secure the object 112 within the truck bed 110. Further, the pull strap 106 allows easy access to the device 100 from the truck's pockets 114 when needed. Then, when not in use, the chain-like component 102 can be positioned within the truck's pockets 114, allowing the device 100 to be tucked away and concealed within the pocket 114 and only exposing the pull strap 106. Thus, the device 100 is easily accessed by pulling up on the pull strap 106 when needed to expose the device 100 and use it to secure the cargo 112. After use, the device 100 is dropped back down and hidden away in the pocket 114 of the truck bed 110 for storage.

As shown in FIG. 4, the device 100 utilizes a padlock 400 to lock down equipment and valuables. Specifically, the padlock 400 is secured to the chain link 302 of the chain-like component 102, securing the chain-like component 102 around the valuable cargo 112 within the truck bed 110. Any suitable padlock 400 can be used with the chain-like component 102 as is known in the art.

As shown in FIG. 5, in operation, a user 116 first presses the pair of spring-loaded wings 200 of the toggle bolt 104 inward. With the wings 200 retracted, the toggle bolt 104 is then inserted into the anchor point 108 and the wings 200 are released, springing outward, securing the toggle bolt 104 within the anchor point 108. The outward pressure of the wings 200 against the anchor point 108, locks the toggle bolt 104 within the anchor point 108. Once secure within the anchor point 108, the device 100 can be stored within the pocket 114 of the truck bed 110 with just the pull strap 106 exposed. Then in use, the user 116 grabs the pull strap 106 and pulls the device 100 free of the pocket 114. The chain-like component 102 is then secured around the cargo 112, along with other securing means as needed (i.e., bungee cords, straps, etc.) within the truck bed 110 and secured. The user 116 then uses the pull strap 106 to pull and tighten the chain-like component 102 around the cargo 112. If needed, a padlock 400 is then added to the chain-like component 102 to further secure any valuables within the truck bed 110.

In yet another embodiment, the truck bed tie down device 100 comprises a plurality of indicia 500. The chain-like component 102 of the device 100 may include advertising, a trademark, or other letters, designs, or characters, printed, painted, stamped, or integrated into the chain-like component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be truck bed, cargo, or brand related.

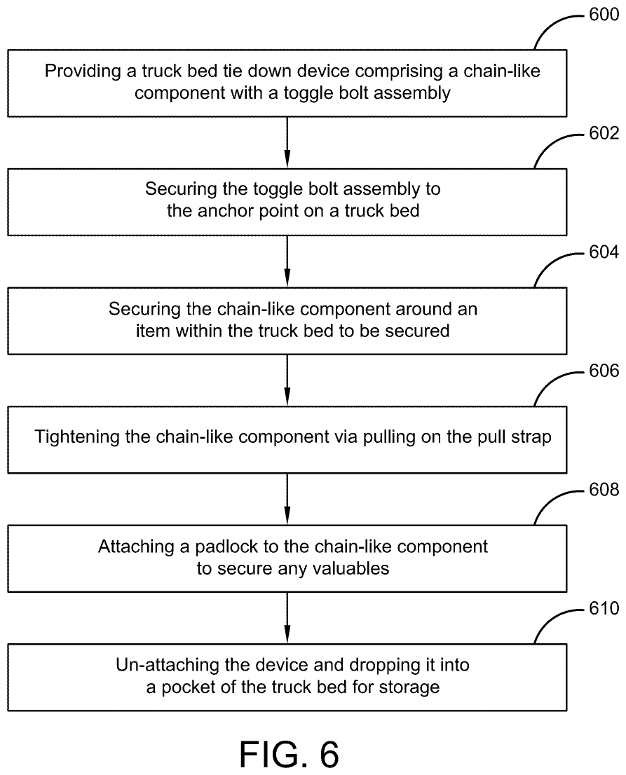

FIG. 6 illustrates a flowchart of the method of securing cargo in a truck bed. The method includes the steps of at 600, providing a truck bed tie down device comprising a chain-like component with a toggle bolt assembly. The method also comprises at 602, securing the toggle bolt assembly to the anchor point on a truck bed. Further, the method comprises at 604, securing the chain-like component around an item within the truck bed to be secured. The method comprises at 606, tightening the chain-like component via pulling on the pull strap. The method also comprises at 608, attaching a padlock to the chain-like component to secure any valuables. Finally, the method comprises at 610, un-attaching the device and dropping it into a pocket of the truck bed for storage.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “truck bed tie down device”, “truck bed device”, “tie down device”, and “device” are interchangeable and refer to the truck bed tie down device 100 of the present invention.

Notwithstanding the forgoing, the truck bed tie down device 100 of the present invention can be of any suitable size and configuration as is known in the art without affecting the overall concept of the invention, provided that it accomplishes the above stated objectives. One of ordinary skill in the art will appreciate that the truck bed tie down device 100 as shown in FIGS. 1-6 is for illustrative purposes only, and that many other sizes and shapes of the truck bed tie down device 100 are well within the scope of the present disclosure. Although the dimensions of the truck bed tie down device 100 are important design parameters for user convenience, the truck bed tie down device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A truck bed tie down device that provides a user with a means for securing cargo within a pickup truck bed, the truck bed tie down device comprising:
a chain-like component;
a toggle bolt assembly; and
a pull strap;
wherein the chain-like component is secured to the toggle bolt assembly and the pull strap;
wherein during use, the toggle bolt assembly is secured within an anchor point of a truck bed;
wherein the chain-like component is secured around cargo within the truck bed to tie down and prevent errant movement; and
further wherein the truck bed tie down device is stored within a pocket of the truck bed and then removed via the pull strap when needed.

2. The truck bed tie down device of claim 1, wherein the truck bed tie down device is utilized with any truck, utility trailer, or vehicle which has a cargo bed and at least one anchor point.

3. The truck bed tie down device of claim 2, wherein the at least one anchor point is positioned in a top rail of a side wall of a pickup truck bed or other vehicle and has a rectangular opening and a pocket directly below.

4. The truck bed tie down device of claim 3, wherein the chain-like component is typically a plurality of chain links secured together at their links into a length which is then wrapped around an object, securing it within the truck bed.

5. The truck bed tie down device of claim 4, wherein the plurality of chain links of the chain-like component allow bungee cords, straps, or rope to be secured to aid with the securing of the object within the truck bed.

6. The truck bed tie down device of claim 5, wherein the chain-like component comprises a protective cover, which wraps fully around the plurality of chain links, cushioning them and preventing them from damaging the truck.

7. The truck bed tie down device of claim 6, wherein the toggle bolt assembly comprises a pair of spring-loaded wings, with a metal screw positioned in a middle of the wings.

8. The truck bed tie down device of claim 7, wherein the spring-loaded wings are folded down and inserted into an anchor point, then released, securing the toggle bolt assembly within the anchor point.

9. The truck bed tie down device of claim 8, wherein the toggle bolt assembly has a drawstring for drawing up and securing the toggle bolt assembly, once it is inserted into the anchor point.

10. The truck bed tie down device of claim 9, wherein the pull strap is attached to the chain-like component via a stainless-steel ring secured to one of the plurality of chain links.

11. The truck bed tie down device of claim 10, wherein the pull strap is made of nylon and UV-resistant materials to provide durability.

12. The truck bed tie down device of claim 11, wherein the pull strap comprises a hand loop for a user to insert their hand into, when pulling on the pull strap.

13. The truck bed tie down device of claim 12, wherein the chain-like component comprises a padlock to lock down equipment and valuables.

14. A truck bed tie down device that provides a user with a means for securing cargo within a pickup truck bed, the truck bed tie down device comprising:
a chain-like component which is typically a plurality of chain links secured together at their links into a length which is then wrapped around an object, securing it within a truck bed;
a toggle bolt assembly comprising a pair of spring-loaded wings, with a metal screw positioned in a middle of the wings; and
a pull strap comprising a hand loop for a user's hand and being made of nylon and UV-resistant materials to provide durability;
wherein the chain-like component is secured to the toggle bolt assembly and the pull strap;
wherein the spring-loaded wings of the toggle bolt assembly are folded down and inserted into an anchor point, then released, securing the toggle bolt assembly within the anchor point;
wherein the chain-like component comprises a protective cover, which wraps fully around the plurality of chain links, cushioning them and preventing them from damaging the truck;
wherein the chain-like component is secured around cargo within the truck bed to tie down and prevent errant movement;
wherein the chain-like component comprises a padlock to lock down equipment and valuables;
further wherein once secured to the chain-like component via a stainless-steel ring, a user pulls on the pull strap to tighten the truck bed tie down device, as needed, to secure the object within the truck bed.

15. The truck bed tie down device of claim 14, wherein the plurality of chain links of the chain-like component allow bungee cords, straps, or rope to be secured to aid with the securing of the object within the truck bed.

16. The truck bed tie down device of claim 14 further comprising a plurality of indicia.

17. The truck bed tie down device of claim 14, wherein the pull strap allows easy access to the truck bed tie down device from being stored in a truck pocket.

18. The truck bed tie down device of claim 17, wherein a user pulls on the pull strap to expose the truck bed tie down device from the truck pocket.

19. The truck bed tie down device of claim 18, wherein after use, the truck bed tie down device is dropped back down and hidden away in the truck pocket for storage, concealing the chain-like component and only exposing the pull strap.

20. A method of securing cargo in a truck bed, the method comprising the following steps:
providing a truck bed tie down device comprising a chain-like component with a toggle bolt assembly;
securing the toggle bolt assembly to the anchor point on a truck bed;
securing the chain-like component around an item within the truck bed to be secured;
tightening the chain-like component via pulling on the pull strap;
attaching a padlock to the chain-like component to secure any valuables; and
un-attaching the device and dropping it into a pocket of the truck bed for storage.
